(19) United States
(12) Patent Application Publication
(10) Pub. No.: US 2023/0162001 A1
(43) Pub. Date: May 25, 2023

(54) CLASSIFICATION DEVICE CONFIGURED TO EXECUTE CLASSIFICATION PROCESSING USING LEARNING MACHINE MODEL, METHOD, AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Shin NISHIMURA, Shiojiri-shi (JP); Hikaru KURASAWA, Matsumoto-shi (JP)

(21) Appl. No.: 18/058,433

(22) Filed: Nov. 23, 2022

(30) Foreign Application Priority Data
Nov. 25, 2021 (JP) 2021-191064

(51) Int. Cl. G06N 3/04

(52) U.S. Cl. CPC G06N 3/04

(57) ABSTRACT

A classification device executes classification processing for data to be classified using a machine learning model including a vector neural network including a plurality of vector neuron layers. The machine learning model includes an input layer, an intermediate layer, and a first output layer and a second output layer that are branched from the intermediate layer, the first output layer is configured to use a first activation function, and the second output layer is configured to use a second activation function that is different from the first activation function.

The present application is based on, and claims priority from JP Application Serial Number 2021-191064, filed Nov. 25, 2021, the disclosure of which is hereby incorporated by reference herein in its entirety.

### BACKGROUND

### 1. Technical Field

The present disclosure relates to a classification device configured to execute classification processing using a machine learning model, a method, and a non-transitory computer-readable storage medium storing a computer program.

### 2. Related Art

U.S. Pat. No. 5,210,798 and WO 2019/083553 each disclose a so-called capsule network as a machine learning model of a vector neural network type using a vector neuron. The vector neuron indicates a neuron where an input and an output are in a vector expression. The capsule network is a machine learning model where the vector neuron called a capsule is a node of a network. The vector neural network-type machine learning model such as a capsule network is applicable to classification for input data.

However, in the related art, although a result of classification is output from the machine learning model, a classification basis for an output class is unknown. In particular, it is difficult to grasp a classification basis with high reliability.

### SUMMARY

According to a first aspect of the present disclosure, there is provided a classification device configured to execute classification processing for data to be classified using a machine learning model including a vector neural network including a plurality of vector neuron layers. The machine learning model includes an input layer, an intermediate layer, and a first output layer and a second output layer that are branched from the intermediate layer, the first output layer is configured to use a first activation function, and the second output layer is configured to use a second activation function that is different from the first activation function.

According to a second aspect of the present disclosure, there is provided a method of executing classification processing for data to be classified using a machine learning model including a vector neural network including a plurality of vector neuron layers. The method includes (a) reading out the machine learning model from a memory, the machine learning model having an input layer, an intermediate layer, and a first output layer and a second output layer that are branched from the intermediate layer, the first output layer being configured to use a first activation function, the second output layer being configured to use a second activation function that is different from the first activation function, (b) reading out a known feature spectrum group from the memory, the known feature spectrum group being obtained from an output of the second output layer when a plurality of pieces of teaching data are input to the machine learning model, and (c) determining a corresponding class of the data to be classified using the machine learning model. The item (c) includes (c1) calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified, (c2) determining the corresponding class of the data to be classified, based on any one of an output of the first output layer, an output of the second output layer, and the similarity degree, and (c3) displaying the corresponding class of the data to be classified and the explanatory information.

According to a third aspect of the present disclosure, there is provided a non-transitory computer-readable storage medium storing a computer program for causing a processor to execute classification processing for data to be classified using a machine learning model including a vector neural network including a plurality of vector neuron layers. The computer program causes the processor to execute processing (a) of reading out the machine learning model from a memory, the machine learning model having an input layer, an intermediate layer, and a first output layer and a second output layer that are branched from the intermediate layer, the first output layer being configured to use a first activation function, the second output layer being configured to use a second activation function that is different from the first activation function, processing (b) of reading out a known feature spectrum group from the memory, the known feature spectrum group being obtained from an output of the second output layer when a plurality of pieces of teaching data are input to the machine learning model, and processing (c) of determining a corresponding class of the data to be classified using the machine learning model. The processing (c) involves processing (c1) of calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified, processing (c2) of determining the corresponding class of the data to be classified, based on any one of an output of the first output layer, an output of the second output layer, and the similarity degree, and processing (c3) of displaying the corresponding class of the data to be classified and the explanatory information.

### BRIEF DESCRIPTION OF THE DRAWINGS

FIG. 1 is a block diagram illustrating a classification system in an exemplary embodiment.

FIG. 2 is an explanatory diagram illustrating a configuration of a machine learning model.

FIG. 3 is an explanatory diagram illustrating a configuration of a layer other than a branched output layer of the machine learning model.

FIG. 4 is a flowchart illustrating a process procedure of preparation steps.

FIG. 5 is an explanatory diagram illustrating a layer in which a parameter is adjusted in Step S120.

FIG. 6 is an explanatory diagram illustrating a layer in which a parameter is adjusted in Step S130.

FIG. 7 is an explanatory diagram illustrating a feature spectrum.

FIG. 8 is an explanatory diagram illustrating a configuration of a known feature spectrum group.

FIG. 9 is a flowchart illustrating a process procedure of classification steps.

FIG. 10 is an explanatory diagram illustrating an example of display of a result of classification.

FIG. 11 is an explanatory diagram illustrating another example of display of a result of classification.

FIG. 12 is an explanatory diagram illustrating a result obtained by comparing an unknown detection rate in a case of presence of a branched output layer with an unknown detection rate in a case of absence of a branched output layer.

FIG. 13 is an explanatory diagram illustrating a method of calculating an unknown detection rate.

### DESCRIPTION OF EXEMPLARY EMBODIMENTS

### A. Exemplary Embodiment

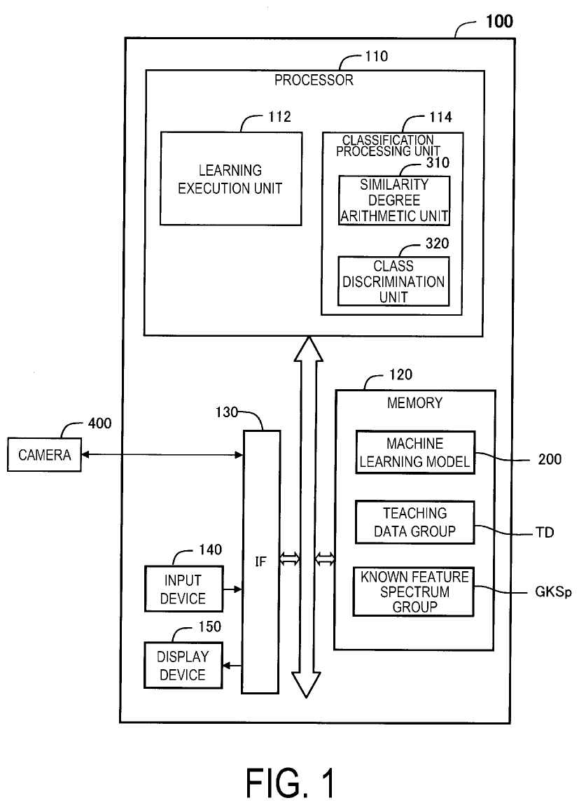

FIG. 1 is a block diagram illustrating a classification system in an exemplary embodiment. The classification system includes an information processing device 100 and a camera 400. The camera 400 captures an image of an inspection target product. A camera that captures a color image may be used as the camera 400. Alternatively, a camera that captures a monochrome image or a spectral image may be used. In the present exemplary embodiment, an image captured by the camera 400 is used as teaching data or data to be classified. Alternatively, data other than an image may be used as teaching data or data to be classified. In such a case, a data to be classified reading device selected in accordance with a data type is used in place of the camera 400.

The information processing device 100 includes a processor 110, a memory 120, an interface circuit 130, and an input device 140 and a display device 150 that are coupled to the interface circuit 130. The camera 400 is also coupled to the interface circuit 130. Although not limited thereto, for example, the processor 110 is provided with a function of executing processing, which is described below in detail, as well as a function of displaying, on the display device 150, data obtained through the processing and data generated in the course of the processing.

The processor 110 functions as a learning execution unit 112 that executes learning of a machine learning model and a classification processing unit 114 that executes classification processing for data to be classified. The classification processing unit 114 includes a similarity degree arithmetic unit 310 and a class discrimination unit 320. Each of the learning execution unit 112 and the classification processing unit 114 are implemented when the processor 110 executes a computer program stored in the memory 120. Alternatively, the learning execution unit 112 and the classification processing unit 114 may be implemented with a hardware circuit. The processor in the present disclosure is a term including such a hardware circuit. Further, one or a plurality of processors that execute classification processing may be a processor included in one or a plurality of remote computers that are coupled via a network.

In the memory 120, a machine learning model 200, a teaching data group TD, and a known feature spectrum group GKSp are stored. The machine learning model 200 is used for processing executed by the classification processing unit 114. A configuration example and an operation of the machine learning model 200 are described later. The teaching data group TD is a group of labeled data used for learning of the machine learning model 200. In the present exemplary embodiment, the teaching data group TD is a set of image data. The known feature spectrum group GKSp is a set of feature spectra that are obtained by inputting the teaching data group TD to the machine learning model 200 that is previously learned. The feature spectrum is described later.

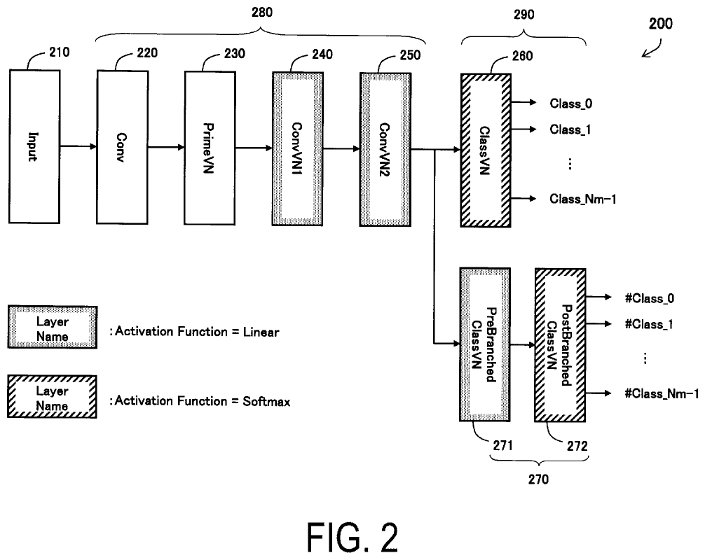

FIG. 2 is an explanatory diagram illustrating a configuration of the machine learning model 200. The machine learning model 200 has an input layer 210, an intermediate layer 280, and an output layer 290. The intermediate layer 280 includes a convolution layer 220, a primary vector neuron layer 230, a first convolution vector neuron layer 240, and a second convolution vector neuron layer 250. The output layer 290 includes the classification vector neuron layer 260 and a branched output layer 270. Those two output layers 260 and 270 are configured as layers branched from the intermediate layer 280. The branched output layer 270 includes a pre-branched classification vector neuron layer 271 and a post-branched classification vector neuron layer 272. Among those layers, the input layer 210 is the lowermost layer, and the output layer 290 is the uppermost layer. Further, each of the input layer 210 and the convolution layer 220 is a layer formed of a scalar neuron, and each of the other layers 230, 240, 250, 260, 271, and 272 is a layer formed of a vector neuron. In the following description, the layers forming the intermediate layer 280 are referred to as the “Cony layer 220”, the “PrimeVN layer 230”, the “ConvVN1 layer 240”, and the “ConvVN2 layer 250”, respectively. Further, the layers 260, 271, and 272 forming the output layer 290 are referred to the “ClassVN layer 260”, the “PreBranchedClassVN layer 271”, and the “PostBranchedClassVN layer 272”, respectively.

In the example of FIG. 2, the two convolution vector neuron layers 240 and 250 are used. However, the number of convolution vector neuron layers is freely selected, and the vector neuron layers may be omitted. However, it is preferred that one or more convolution vector neuron layers be used.

The ClassVN layer 260 corresponds to the “first output layer”, and the branched output layer 270 corresponds to the “second output layer” in the present disclosure. Further, the PreBranchedClassVN layer 271 corresponds to the “pre layer”, and the PostBranchedClassVN layer 272 corresponds to the “post layer”. In the present exemplary embodiment, the branched output layer 270 is formed of two layers including the pre layer 271 and the post layer 272. However, one or more vector neuron layers may be added between the layers 271 and 272. Further, the post layer 272 may be omitted, and the branched output layer 270 may be formed of only the pre layer 271. However, when the branched output layer 270 is formed to include the post layer 272, reliability of explanatory information obtained from an output of the pre layer 271 can be improved, which is preferable.

Determination values Class_0 to Class_Nm−1 for Nm classes are output from the ClassVN layer 260 with respect to the data to be classified that is input. Here, Nm is an integer equal to or greater than 2, and is an integer equal to or greater than 3 in a representative example. Similarly, determination values #Class_0 to #Class_Nm−1 for the Nm classes are output from the PostBranchedClassVN layer 272. A method of using those two types of the determination values Class_0 to Class_Nm−1, and #Class_0 to #Class_Nm−1 is described later.

In FIG. 2, for the vector neuron layers after the ConvVN1 layer 240, activation function types are shown by hatching. Specifically, the activation function of the layers 240, 250, and 271 is a linear function shown in Equation (A1) given below, and the activation function of the layers 260 and 272 is a softmax function shown in Equation (A2) given below. The activation function that can be used in each of the layers is further described later. Note that the activation function is also referred to as a “normalization function”.

$$[ Mathematical Expression 1 ]$$

$$[ Math . 1 ]$$

$${a}_{j} = \frac{‖ {u}_{j} ‖}{{Σ}_{k} ‖ {u}_{k} ‖} \qquad ( A1 )$$

$${a}_{j} = \frac{exp ( β ‖ {u}_{j} ‖ )}{{Σ}_{k} exp ( β ‖ {u}_{k} ‖ )} \qquad ( A2 )$$

Where

aⱼ is a norm of an output vector after activation in a j-th neuron in the layer;

uⱼ is an output vector before activation in the j-th neuron in the layer;

∥uⱼ∥ is a norm of a vector uⱼ;

Σₖ is a calculation for obtaining a sum of all the neurons in the layer; and

β is a freely-selected positive coefficient. Note that the determination values Class_0 to Class_Nm−1 and #Class_0 to #Class_Nm−1 being outputs of the layers 260 and 272 are scalar values, and hence aⱼ is used as a determination value as it is. aⱼ is referred to as an “activation value” or an “activation coefficient”.

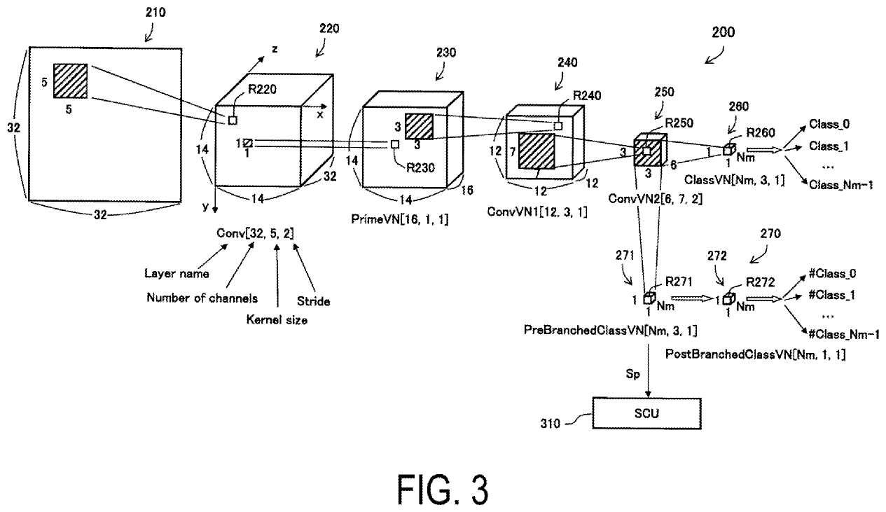

FIG. 3 is an explanatory diagram illustrating a configuration of each layer of the machine learning model 200 illustrated in FIG. 2. An image having a size of 32×32 pixels is input into the input layer 210. A configuration of each of the layers other than the input layer 210 is described as follows.
Cony layer 220: Cony [32, 5, 2]
PrimeVN layer 230: PrimeVN [16, 1, 1]
ConvVN1 layer 240: ConvVN1 [12, 3, 1]
ConvVN2 layer 250: ConvVN2 [6, 7, 2]
ClassVN layer 260: ClassVN [Nm, 3, 1]
PreBranchedClassVN layer 271: PreBranchedClassVN [Nm, 3, 1]
PostBranchedClassVN layer 272: PostBranchedClassVN [Nm, 1, 1]
Vector dimension VD: VD=16

In the description for each of the layers, the character string before the brackets indicates a layer name, and the numbers in the brackets indicate the number of channels, a kernel surface size, and a stride in the stated order. For example, the layer name of the Conv layer 220 is “Cony”, the number of channels is 32, the kernel surface size is 5×5, and the stride is two. In FIG. 3, such description is given below each of the layers. A rectangular shape with hatching in each of the layers indicates the kernel surface size that is used for calculating an output vector of an adjacent upper layer. In the present exemplary embodiment, input data is in a form of image data, and hence the kernel surface size is also two-dimensional. Note that the parameter values used in the description of each of the layers are merely examples, and may be changed freely.

Each of the input layer 210 and the Conv layer 220 is a layer configured as a scalar neuron. Each of the other layers 230 to 260, 271, and 272 is a layer configured as a vector neuron. The vector neuron is a neuron where an input and an output are in a vector expression. In the description given above, the dimension of an output vector of an individual vector neuron is 16, which is constant. In the description given below, the term “node” is used as a superordinate concept of the scalar neuron and the vector neuron.

In FIG. 3, with regard to the Conv layer 220, a first axis x and a second axis y that define plane coordinates of node arrangement and a third axis z that indicates a depth are illustrated. Further, it is shown that the sizes in the Conv layer 220 in the directions x, y, and z are 14, 14, and 32. The size in the direction x and the size in the direction y indicate the “resolution”. The size in the direction z indicates the number of channels. Those three axes x, y, and z are also used as the coordinate axes expressing a position of each node in the other layers. However, in FIG. 3, illustration of those axes x, y, and z is omitted for the layers other than the Conv layer 220.

As is well known, a resolution W1 after convolution is given with the following equation.

W1=Ceil{(W0−Wk+1)/S} (A3)

Here, W0 is a resolution before convolution, Wk is the kernel surface size, S is the stride, and Ceil{X} is a function of rounding up digits after the decimal point in the value X.

The resolution of each of the layers illustrate in FIG. 3 is an example while assuming that the resolution of the input data is 32, and the actual resolution of each of the layers is changed appropriately in accordance with a size of the input data.

The ClassVN layer 260 has Nm channels. In general, Nm is the number of classes that can be distinguished from each other using the machine learning model 200. Nm is an integer equal to or greater than 2, and is an integer equal to or greater than 3 in a representative example. The determination values Class_0 to Class_Nm−1 for the Nm classes are output from the Nm channels of the ClassVN layer 260. Similarly, the determination values #Class_0 to #Class_Nm−1 for the Nm classes are output from the Nm channels of the PostBranchedClassVN layer 272. A corresponding class of the data to be classified can be determined using any one of the determination values Class_0 to Class_Nm−1 that are output from the ClassVN layer 260 and the determination values #Class_0 to #Class_Nm−1 that are output from the PostBranchedClassVN layer 272. For example, when the determination values #Class_0 to #Class_Nm−1 of the PostBranchedClassVN layer 272 are used, a class having the greatest value in those values is determined as the corresponding class of the data to be classified. Further, the greatest value in the determination values #Class_0 to #Class_Nm−1 is less than a predetermined threshold value, it can be determined that the class of the data to be classified is unknown.

Note that the corresponding class of the data to be classified may be determined using a similarity degree for each class, which is calculated from an output of the PreBranchedClassVN layer 271, instead of the determination values of the ClassVN layer 260 or the determination values of the PostBranchedClassVN layer 272. The similarity degree for each class is described later.

In FIG. 3, a partial region Rn is further illustrated in each of the layers 220, 230, 240, 250, 260, 271, and 272. The suffix “n” of the partial region Rn indicates the reference symbol of each of the layers. For example, the partial region R220 indicates the partial region in the Cony layer 220. The “partial region Rn” is a region of each of the layers that is specified with a plane position (x, y) defined by a position in the first axis x and a position in the second axis y and includes a plurality of channels along the third axis z. The partial region Rn has a dimension “Width”×“Height”×“Depth” corresponding to the first axis x, the second axis y, and the third axis z. In the present exemplary embodiment, the number of nodes included in one “partial region Rn” is “1×1× the number of depths”, that is, “1×1× the number of channels”.

As illustrated in FIG. 3, a feature spectrum Sp, which is described later, is calculated from an output of the PreBranchedClassVN layer 271, and is input to similarity degree arithmetic unit 310. The similarity degree arithmetic unit 310 calculates the similarity degree for each class, which is described later, using the feature spectrum Sp and the known feature spectrum group GKSp that is generated in advance.

In the present disclosure, a vector neuron layer used for calculation of the similarity degree is also referred to as a “specific layer”. As the specific layer, the vector neuron layers other than the PreBranchedClassVN layer 271 may be used. One or more vector neuron layers may be used, and the number of vector neuron layers is freely selectable. Note that a configuration of the feature spectrum and an arithmetic method of the similarity degree using the feature spectrum are described later.

An output of the branched output layer 270 may be used for generating the explanatory information relating to the classification result. As the explanatory information, information other than the similarity degree for each class, which is described above, may be used. For example, an output vector of the PreBranchedClassVN layer 271 may be used as the explanatory information as it is. However, a user easily understands the explanatory information using the similarity degree described above, which is advantageous.

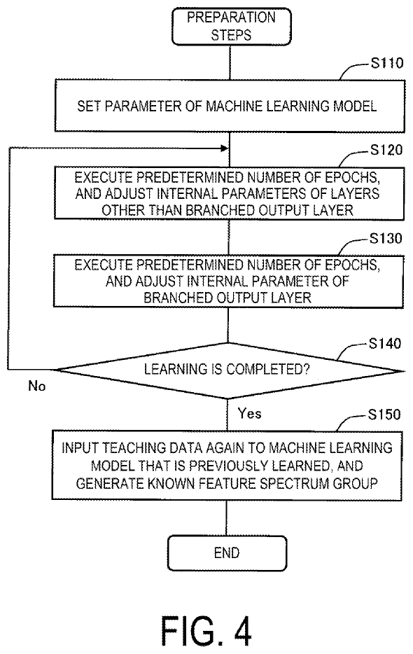

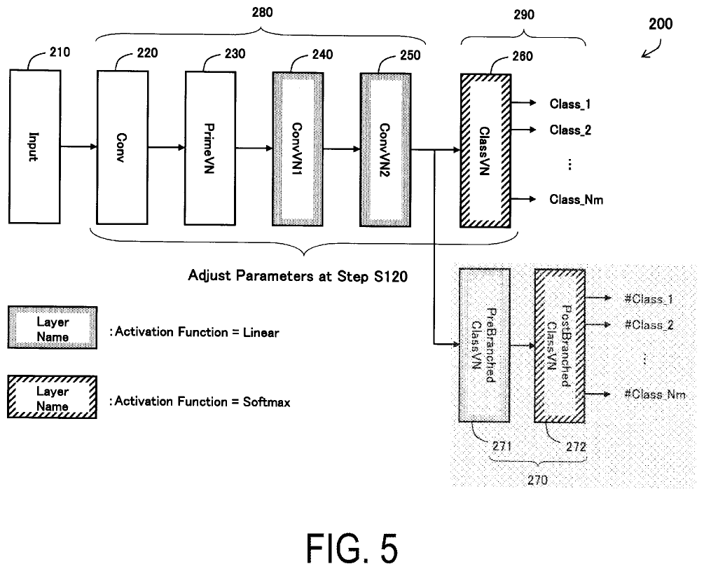

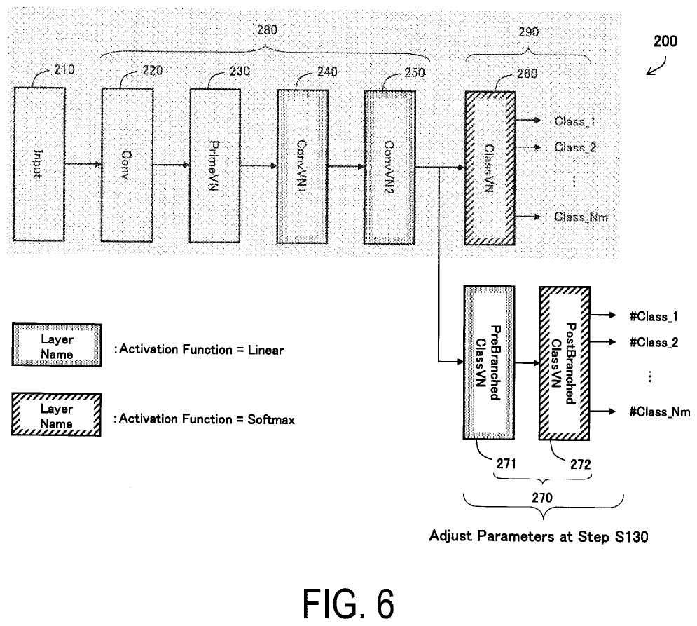

FIG. 4 is a flowchart illustrating a process procedure of preparation steps of the machine learning model. FIG. 5 illustrates a layer in which an internal parameter is adjusted in Step 120 in FIG. 4, and FIG. 6 illustrates a layer in which an internal parameter is adjusted in Step 130 in FIG. 4.

In Step S110, a user generates a machine learning model used for classification processing, and sets a parameter therefor. In the present exemplary embodiment, the machine learning model 200 illustrated in FIG. 2 and FIG. 3 is generated, and a parameter therefor is set. Step S120 to Step S140 are steps for executing learning of the machine learning model 200 using the teaching data group TD. An individual piece of the teaching data is provided with a label in advance. For example, the machine learning model 200 has the Nm known classes, and hence the individual piece of the teaching data is provided with any one of the Nm labels corresponding to the Nm classes.

In the present exemplary embodiment, it is assumed that images showing numbers 0 to 9 are used as the teaching data. Thus, Nm is 10, and the individual piece of the teaching data is provided with any one of the labels 0 to 9.

In Step S120, the learning execution unit 112 executes a predetermined number of epochs using the teaching data, and adjusts the internal parameters in the layers other than the branched output layer 270. For example, the number of epochs indicated with the term “the predetermined number of epochs” may be one, or may be multiple values such as 100. In Step S120, as illustrated in FIG. 5, the internal parameters are adjusted in the layers 220, 230, 240, 250, and 260. The “internal parameters” contain a kernel value for a convolution calculation. Note that learning in Step S120 may be executed by a segmenting method other than “the predetermined number of epochs”. For example, learning may be executed until a value of the Loss function is reduced at a predetermined rate or by a predetermined amount from the value before execution of Step S120. Alternatively, learning may be executed until a value of accuracy is increased at a predetermined rate or by a predetermined amount from the value before execution of Step S120.

In Step S130, the learning execution unit 112 executes the predetermined number of epochs using the teaching data, and adjusts the internal parameter of the branched output layer 270. The number of epochs executed in Step S130 is preferably equal to the number of epochs in Step S120 described above. In Step S130, as illustrated in FIG. 6, the internal parameters of the layers 271 and 272 are adjusted while maintaining the internal parameters of the layers 220, 230, 240, 250, and 260 without a change.

In Step S140, the learning execution unit 112 determines whether learning is completed. For example, the determination is executed based on whether learning of the predetermined number of epochs is completed. When learning is not completed, the procedure returns to Step S120, and Step S120 and Step S130 described above are executed again. When learning is completed, the procedure proceeds to subsequent Step S150. Note that, when the number of epochs executed in Step S120 and Step S130 is sufficiently large, Step S140 may be omitted, and the procedure may directly proceed to Step S150.

In Step S150, the learning execution unit 112 inputs a plurality of pieces of teaching data to the machine learning model 200 that is previously learned, and generates the known feature spectrum group GKSp. The known feature spectrum group GKSp is a set of feature spectra, which is described later.

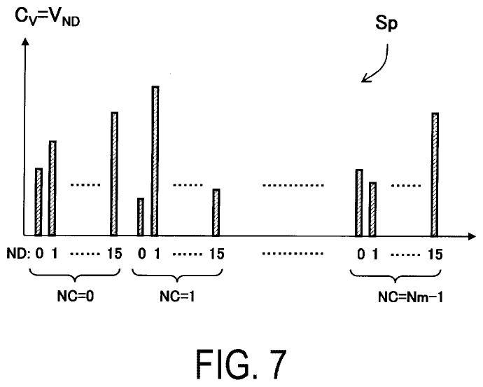

FIG. 7 is an explanatory diagram illustrating the feature spectrum Sp obtained by inputting freely-selected input data to the machine learning model 200 that is previously learned. Here, description is made on the feature spectrum Sp obtained from an output of the PreBranchedClassVN layer 271. In FIG. 7, the horizontal axis shows a spectrum position indicated with a combination of a channel number NC and an element number ND of an output vector of a node at one plane position (x, y) of the PreBranchedClassVN layer 271. In the present exemplary embodiment, the vector dimension of the node is 16, and hence the element number ND of the output vector is denoted with 0 to 15, which is sixteen in total. Further, the number of channels of the PreBranchedClassVN layer 271 is Nm, and thus the channel number NC is denoted with 0 to Nm−1, which is Nm in total.

The vertical axis in FIG. 7 indicates a feature value C_{V} at each of the spectrum positions. In this example, the feature value C_{V} is a value VND of each of the elements of the output vectors. Note that, as the feature value C_{V}, a value obtained by multiplying the value VND of each of the elements of the output vectors by the activation value aⱼ described above. Alternatively, the activation value aⱼ may directly be used. In the latter case, the number of feature values C_{V} included in the feature spectrum Sp is equal to the number of channels, which is Nm. Note that the activation value aⱼ is a value corresponding to a vector length of the output vector of the node.

The feature spectrum Sp is obtained for the individual plane position (x, y). The number of feature spectra Sp that can be obtained from an output of the PreBranchedClassVN layer 271 with respect to one piece of input data is equal to the number of plane position (x, y) of the PreBranchedClassVN layer 271, which is one.

The learning execution unit 112 inputs the teaching data again to the machine learning model 200 that is previously learned, calculates the feature spectra Sp illustrated in FIG. 7, and registers the feature spectra Sp as the known feature spectrum group GKSp in the memory 120.

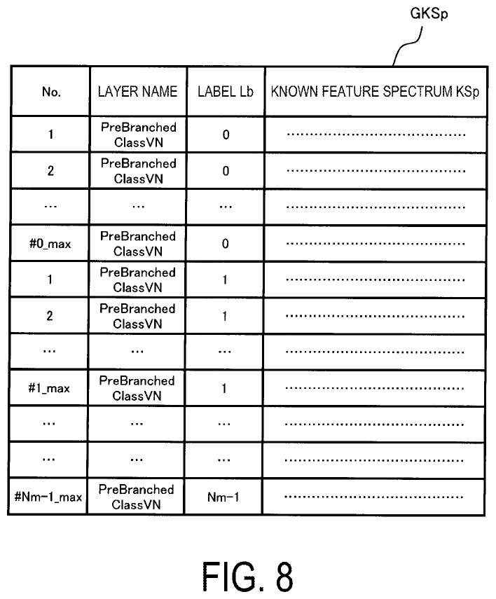

FIG. 8 is an explanatory diagram illustrating a configuration of the known feature spectrum group GKSp. Each of the individual records of the known feature spectrum group GKSp contains a record number, a layer name, a label Lb, and a known feature spectrum KSp. The known feature spectrum KSp is the same as the feature spectrum Sp in FIG. 7, which is obtained according to input of the teaching data. In the example of FIG. 8, the known feature spectra KSp associated with values of the individual labels Lb are generated from outputs of the PreBranchedClassVN 271 according to the plurality of pieces of teaching data, and registered. For example, #0_max known feature spectra KSp are registered in association with the label Lb=0, and #1_max known feature spectra KSp are registered in association with the label Lb=1, and #Nm−1_max known feature spectra KSp are registered in association with the label Lb=Nm−1. Each of #0_max, #1_max, and #Nm−1_max is an integer equal to or greater than 2. As described above, the individual labels Lb correspond to known classes that are different from each other. Thus, it can be understood that each of the known feature spectra KSp in the known feature spectrum group GKSp is registered in association with one class of the plurality of known classes.

Note that the teaching data used in Step S150 is not required to be the same as the plurality of pieces of teaching data used in Step S120 and Step S130. However, when part of or an entirety of the plurality of pieces of teaching data used in Step S120 and Step S130 is also used in Step S150, preparation for new teaching data is not required, which is advantageous.

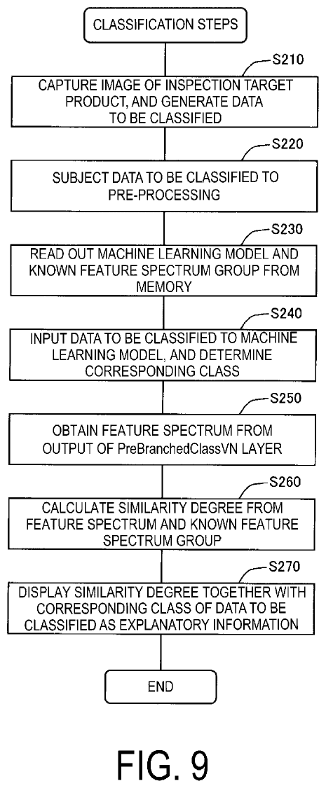

FIG. 9 is a flowchart illustrating a process procedure of classification steps using the machine learning model that is previously learned. IN Step S210, the classification processing unit 114 uses the camera 400 to capture an image of an inspection target product, and thus generates the data to be classified. In Step S220, the classification processing unit 114 subjects the data to be classified to pre-processing as required. As the pre-processing, clipping, resolution adjustment, or the like may be executed. Note that the pre-processing may be omitted. In Step S230, the classification processing unit 114 reads out the machine learning model 200 that is previously learned and the known feature spectrum group GKSp from the memory 120.

In Step S240, the class discrimination unit 320 inputs the data to be classified to the machine learning model 200, and determines the corresponding class of the data to be classified. For example, this determination may be executed using any one of the determination values Class_0 to Class_Nm−1 that are output from the ClassVN layer 260 and the determination values #Class_0 to #Class_Nm−1 that are output from the PostBranchedClassVN layer 272. Further, as described later, the corresponding class of the data to be classified may be determined using the similarity degree for each class.

In Step S250, the classification processing unit 114 obtains the feature spectrum Sp, which is illustrated in FIG. 7, using an output of the PreBranchedClassVN layer 271.

In Step S260, the similarity degree arithmetic unit 310 calculates a similarity degree using the feature spectrum Sp obtained in Step S250 and the known feature spectrum group GKSp illustrated in FIG. 8. As described below, as the similarity degree, any one of the similarity degree for each class and the maximum similarity degree without consideration of a class may be used.

For example, a similarity degree S(Class) for each class may be calculated using an equation given below.

S(Class)=max[G{Sp,KSp(Class,k)}] (A4), where

“Class” is an order number with respect to a class;

G{a, b} is a function for obtaining a similarity degree of a and b;

Sp is a feature spectrum obtained according to the data to be classified;

KSp (Class, k) are all the known feature spectra associated with a specific “Class”;

k is an order number of the known feature spectrum; and

max[X] is a logic operation for obtaining a maximum value of X. For example, as the function G{a, b} for obtaining a similarity degree, a cosine similarity degree, a similarity degree using a distance such as a Euclidean distance, or the like may be used. The similarity degree S(Class) is a maximum value of similarity degrees calculated between the feature spectrum Sp and all the known feature spectra KSp (Class, k) corresponding to the specific class. The similarity degree S(Class) described above is obtained for each of the Nm classes. The similarity degree S(Class) indicates a degree at which the data to be classified is similar to a feature of each class. The similarity degree S(Class) can be used as the explanatory information relating to the classification result of the data to be classified.

A maximum similarity degree S(A11) without consideration of a class may be calculated using an equation given below, for example.

S(A11)=max[G{Sp,KSp(k)}] (A5) where,

KSp(k) is a k-th known feature spectrum of all the known feature spectra.

The maximum similarity degree S(A11) is a maximum value of similarity degrees between the feature spectrum Sp and all the known feature spectra KSp. A known feature spectrum KSp(k) providing the maximum similarity degree S(A11) can be specified. Thus, a label, that is, a class can be specified from the known feature spectrum group GKSp illustrated in FIG. 8. The maximum similarity degree S(A11) can be used as the explanatory information for describing a classification result whether the data to be classified belongs to known data or unknown data.

Note that the similarity degree S(Class) for each class indicates a degree to which the data to be classified is similar to a feature of each class. Thus, the corresponding class of the data to be classified may be determined using the similarity degree S(Class) for each class. For example, when the similarity degree S(Class) of a certain class is equal to or greater than a predetermined threshold value, it can be determined that the data to be classified belongs to the class. Meanwhile, when the similarity degrees S(Class) of all the classes are less than the threshold value, it can be determined that the data to be classified is unknown. Further, the corresponding class of the data to be classified may be determined using the maximum similarity degree S(A11).

Further, instead of determining the corresponding class of the data to be classified through only use of the similarity degree, the corresponding class of the data to be classified may be determined using the similarity degree and any one of the determination values Class_0 to Class_Nm−1 of the ClassVN layer 260 and the determination values #Class_0 to #Class_Nm−1 of the PostBranchedClassVN layer 272. For example, when the corresponding class determined from the similarity degree matches with the corresponding class determined from the determination values #Class_0 to #Class_Nm−1 of the PostBranchedClassVN layer 272, it can be determined that the data to be classified belongs to the class. Further, when the corresponding class determined from the similarity degree do not match with the corresponding class determined from the determination values #Class_0 to #Class_Nm−1 of the PostBranchedClassVN layer 272, it can be determined that the data to be classified belongs to an unknown class.

In Step S270, the classification processing unit 114 displays the similarity degree as the explanatory information together with the corresponding class of the data to be classified the display device 150. As the similarity degree, any one of the similarity degree S(Class) for each class and the maximum similarity degree S(A11) that are described above can be used. In the following description, description is made on an example in which the similarity degree S(Class) for each class is used as the explanatory information.

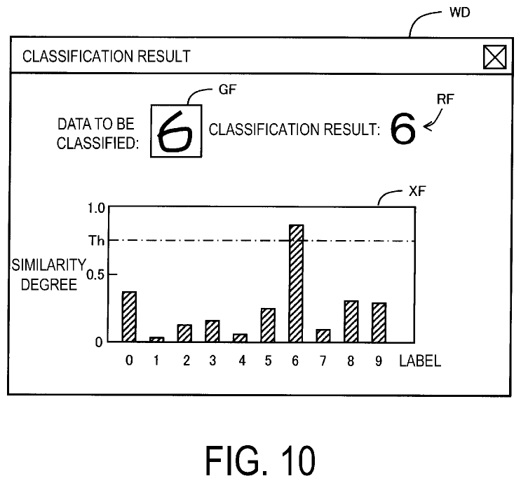

FIG. 10 is an explanatory diagram illustrating an example of display of a result of classification. An image of data to be classified GF, a classification result RF, and explanatory information XF are displayed on a result display window WD. In this example, the classification result RF is a number “6”. As the explanatory information XF, values of the similarity degrees S(Class) for labels 0 to 9 corresponding to numbers 0 to 9, in other words, classes 0 to 9, are respectively shown in a bar chart. The similarity degree for the label 6 is sufficiently higher than the similarity degrees for the other labels. Thus, a user can understand from the explanatory information XF that the classification result RF is reliable. In the example of FIG. 10, a threshold value Th is also displayed. The threshold value Th is used for determining the corresponding class using the similarity degree.

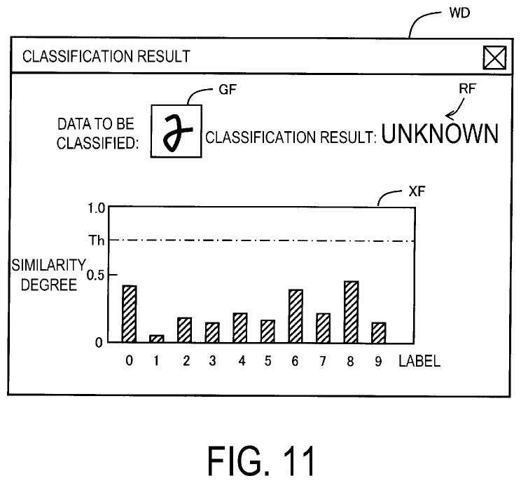

FIG. 11 is an explanatory diagram illustrating another example of display of a result of classification. In this example, the classification result RF of the data to be classified is determined as “unknown”. The similarity degrees indicated in the explanatory information XF are sufficiently small with respect to all the labels. Thus, a user can understand from the explanatory information XF that the classification result RF being “unknown” is reliable.

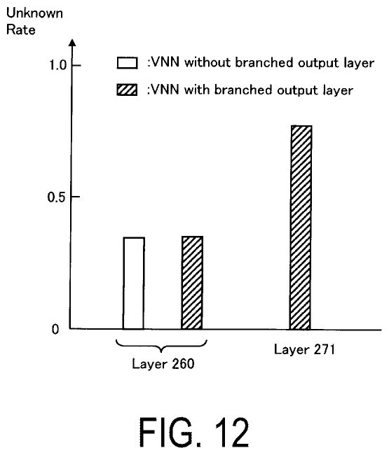

FIG. 12 is an explanatory diagram illustrating a result obtained by comparing an unknown detection rate in a case of presence of the branched output layer 270 with an unknown detection rate in a case of absence of the branched output layer 270. Here, for a virtual model obtaining by omitting the branched output layer 270 from the machine learning model 200 illustrated in FIG. 3, an unknown detection rate is shown. The unknown detection rate is a rate at which unknown data is correctly determined as unknown when classification for the unknown data is executed based on a similarity degree using a feature spectrum obtained from an output of the ClassVN layer 260. Further, for the machine learning model 200 including the branched output layer 270, an unknown detection rate is shown. The unknown detection rate is a rate at which unknown data is correctly determined as unknown when classification of the unknown data is executed based on a similarity degree using a feature spectrum obtained from an output of each of the ClassVN layer 260 and the PreBranchedClassVN layer 271.

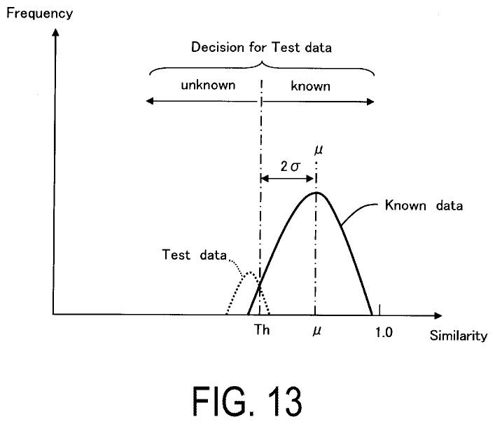

FIG. 13 is an explanatory diagram illustrating a method of calculating an unknown detection rate. In FIG. 13, the horizontal axis indicates the similarity degree, and the vertical axis indicates frequency. In this processing, an average μ and a variance σ of similarities for test data belonging to a known class are calculated, and μ−2σ is used as the threshold value Th. Further, the test data with a similarity degree less than the threshold value Th is determined as unknown, and the test data with a similarity degree equal to greater than the threshold value Th is determined as known. At this state, a rate at which the test data belonging to the unknown class is correctly determined as unknown is calculated as an unknown detection rate.

As understood from the result in FIG. 12, the similarity degree calculated from the output of the PreBranchedClassVN layer 271 in the machine learning model 200 provided with the branched output layer 270 has higher reliability than the similarity degree calculated from the output of the ClassVN layer 260 of the machine learning model without the branched output layer 270. Thus, when the branched output layer 270 is provided the explanatory information with higher reliability can be generated.

In general, the softmax function is suitable as the activation function of the output layer of the neural network for executing classification. However, the softmax function has a characteristics of emphasizing on an intensity difference and compressing information, and hence a feature spectrum of the output layer may similarly be deformed or compressed. Thus, reliability of the explanatory information tends to be degraded. In view of this, the softmax function is used as the activation function of the ClassVN layer 260 being the first output layer of the machine learning model 200, an activation function other than the first output layer is preferably used as the activation function of the PreBranchedClassVN layer 271. In this manner, the explanatory information with high reliability can be generated using an output of the PreBranchedClassVN layer 271. Further, a difference is emphasized, and information is compressed with the softmax function, and hence a layer before the layer using the softmax function tends to generate rich information having strength to bear compression. With this, reliability of the explanatory information contrarily tends to be improved. Thus, when the second output layer is generated through branching, reliability of the explanatory information of the layer before the original first output layer can be secured.

In the exemplary embodiment described above, the softmax function is used as the activation function of the ClassVN layer 260, and the linear function is used the activation function of the PreBranchedClassVN layer 271. It is only required that the PreBranchedClassVN layer 271 be configured to use the activation function different from the activation function used in the ClassVN layer 260. Thus, other activation functions may be used as the activation functions of the two layers 260 and 271. In this case, the explanatory information relating to the classification result can also be generated using one of the two layers 260 and 271. Examples of the other activation function may include an identity function, a step function, a Sigmoid function, a tank function, a softplus function, ReLU, Leaky ReLU, Parametric ReLU, ELU, SELU, a Swish function, and a Mish function.

As described above, in the present exemplary embodiment, the branched output layer 270 being the second layer is provided in addition to the ClassVN layer 260 being the first output layer, and the second output layer uses the activation function different from that of the first output layer. Thus, the explanatory information with high reliability for classification can be generated using any one of the first output layer and the second output layer. Further, in the present exemplary embodiment, the similarity degree for each class between the feature spectrum obtained from an output of the branched output layer 270 being the second output layer and the known feature spectrum group can be utilized as the explanatory information with high reliability.

### B. Arithmetic Method of Output Vector in Each Layer of Machine Learning Model

Arithmetic methods for obtaining an output of each of the layers illustrated in FIG. 3 are as follows.

For each of the nodes of the PrimeVN layer 230, a vector output of the node is obtained by regarding scalar outputs of 1×1×32 nodes of the Conv layer 220 as 32-dimensional vectors and multiplying the vectors by a transformation matrix. In the transformation matrix, a surface size is a 1×1 kernel element. The transformation matrix is updated by learning of the machine learning model 200. Note that processing in the Conv layer 220 and processing in the PrimeVN layer 230 may be integrated so as to configure one primary vector neuron layer.

When the PrimeVN layer 230 is referred to as a “lower layer L”, and the ConvVN1 layer 240 that is adjacent on the upper side is referred to as an “upper layer L+1”, an output of each node of the upper layer L+1 is determined using the following equations.

$$[ Mathematical Expression 2 ]$$

$$[ Math . 2 ]$$

$${v}_{ij} = {W}_{ij}^{L} {M}_{i}^{L} \qquad ( E1 )$$

$${u}_{j} = {Σ}_{i} {v}_{ij} \qquad ( E2 )$$

$${a}_{j} = F ( ‖ {u}_{j} ‖ ) \qquad ( E3 )$$

$${M}_{j}^{L + 1} = {a}_{j} ⨯ \frac{1}{‖ {u}_{j} ‖} {u}_{j} \qquad ( E4 )$$

where

M^{L}ᵢ is an output vector of an i-th node in the lower layer L;

M^{L+1}ⱼ is an output vector of a j-th node in the upper layer L+1;

vᵢⱼ is a predicted vector of the output vector M^{L+1}ⱼ;

W^{L}ᵢⱼ is a predicted matrix for calculating the predicted vector vᵢⱼ from the output vector M^{L}ᵢ of the lower layer L;

uⱼ is a sum vector being a sum of the predicted vector vᵢⱼ, that is, a linear combination;

aⱼ is an activation value being a normalization coefficient obtained by normalizing a norm |uⱼ| of the sum vector uⱼ; and

F(X) is a normalization function for normalizing X.

For example, as the normalization function F(X), Equation (E3a) or Equation (E3b) given below may be used.

$$[ Mathematical Expression 3 ]$$

$$[ Math . 3 ]$$

$${a}_{j} = F ( ‖ {u}_{j} ‖ ) = softmax ( ‖ {u}_{j} ‖ ) = \frac{exp ( β ‖ {u}_{j} ‖ )}{{Σ}_{k} exp ( β ‖ {u}_{k} ‖ )} \qquad ( E3a )$$

$${a}_{j} = F ( ‖ {u}_{j} ‖ ) = \frac{‖ {u}_{j} ‖}{{Σ}_{k} ‖ {u}_{k} ‖} \qquad ( E3b )$$

where

k is an ordinal number for all the nodes in the upper layer L+1; and

β is an adjustment parameter being a freely-selected positive coefficient, for example, β=1.

In Equation (E3a) given above, the activation value aⱼ is obtained by normalizing the norm |uⱼ| of the sum vector uⱼ with the softmax function for all the nodes in the upper layer L+1. Meanwhile, in Equation (E3b), the norm |uⱼ| of the sum vector uⱼ is divided by the sum of the norm |uⱼ| of all the nodes in the upper layer L+1. With this, the activation value aⱼ is obtained. Equation (E3a) and Equation (E3b) are the same as Equation (A2) and Equation (A1) given above. Note that, as the normalization function F(X), a function other than Equation (E3a) and Equation (E3b) may be used.

For sake of convenience, the ordinal number i in Equation (E2) given above is allocated to each of the nodes in the lower layer L for determining the output vector M^{L+1}ⱼ of the j-th node in the upper layer L+1, and is a value from 1 to n. Further, the integer n is the number of nodes in the lower layer L for determining the output vector M^{L+1}ⱼ of the j-th node in the upper layer L+1. Therefore, the integer n is provided in the equation given below.

n=Nk×Nc (E5)

Here, Nk is a kernel surface size, and Nc is the number of channels of the PrimeVN layer 230 being a lower layer. In the example of FIG. 3, Nk=9 and Nc=16. Thus, n=144.

One kernel used for obtaining an output vector of the ConvVN1 layer 240 has 144 (3×3×16) elements, each of which has a surface size being a kernel size of 3×3, and has a depth being the number of channels in the lower layer of 16. Each of the elements is a prediction matrix W^{L}ᵢⱼ. Further, in order to generate output vectors of 12 channels of the ConvVN1 layer 240, 12 kernel pairs are required. Therefore, the number of predication matrices W^{L}ᵢⱼ of the kernels used for obtaining output vectors of the ConvVN1 layer 240 is 1,728 (144×12). Those prediction matrices W^{L}ᵢⱼ are updated by learning of the machine learning model 200.

As understood from Equation (E1) to Equation (E4) given above, the output vector M^{L+1}ⱼ of each of the nodes in the upper layer L+1 is obtained by the following calculation.

(A) the predicted vector vᵢⱼ is obtained by multiplying the output vector M^{L}ᵢ of each of the nodes in the lower layer L by the prediction matrix W^{L}ᵢⱼ;

(b) the sum vector uⱼ being a sum of the predicted vectors vᵢⱼ of the respective nodes in the lower layer L, which is a linear combination, is obtained;

(c) the activation value aⱼ being a normalization coefficient is obtained by normalizing the norm |uⱼ| of the sum vector uⱼ; and

(d) the sum vector uⱼ is divided by the norm |uⱼ|, and is further multiplied by the activation value aⱼ.

Note that the activation value aⱼ is a normalization coefficient that is obtained by normalizing the norm |uⱼ| for all the nodes in the upper layer L+1. Therefore, the activation value aⱼ can be considered as an index indicating a relative output intensity of each of the nodes among all the nodes in the upper layer L+1. The norm used in Equation (E3), Equation (E3a), Equation (E3b), and Equation (4) is an L2 norm indicating a vector length in a general example. In this case, the activation value aⱼ corresponds to a vector length of the output vector M^{L+1}ⱼ. The activation value aⱼ is only used in Equation (E3) and Equation (E4) given above, and hence is not required to be output from the node. However, the upper layer L+1 may be configured so that the activation value aⱼ is output to the outside.

A configuration of the vector neural network is substantially the same as a configuration of the capsule network, and the vector neuron in the vector neural network corresponds to the capsule in the capsule network. However, the calculation with Equation (E1) to Equation (E4) given above, which are used in the vector neural network, is different from a calculation used in the capsule network. The most significant difference between the two calculations is that, in the capsule network, the predicted vector vᵢⱼ in the right side of Equation (E2) given above is multiplied by a weight and the weight is searched by repeating dynamic routing for a plurality of times. Meanwhile, in the vector neural network of the present exemplary embodiment, the output vector M^{L+1}ⱼ is obtained by calculating Equation (E1) to Equation (E4) given above once in a sequential manner. Thus, there is no need of repeating dynamic routing, and the calculation can be executed faster, which are advantageous points. Further, the vector neural network of the present exemplary embodiment has a less memory amount, which is required for the calculation, than the capsule network. According to an experiment conducted by the inventor of the present disclosure, the vector neural network requires approximately ⅓ to ½ of the memory amount of the capsule network, which is also an advantageous point.

The vector neural network is similar to the capsule network in that a node with an input and an output in a vector expression is used. Therefore, the vector neural network is also similar to the capsule network in that the vector neuron is used. Further, in the plurality of layers 220 to 260, and 270, the upper layers indicate a feature of a larger region, and the lower layers indicate a feature of a smaller region, which is similar to the general convolution neural network. Here, the “feature” indicates a feature included in input data to the neural network. In the vector neural network or the capsule network, an output vector of a certain node contains space information indicating information relating to a spatial feature expressed by the node. In this regard, the vector neural network or the capsule network are superior to the general convolution neural network. In other words, a vector length of an output vector of the certain node indicates an existence probability of a feature expressed by the node, and the vector direction indicates space information such as a feature direction and a scale. Therefore, vector directions of output vectors of two nodes belonging to the same layer indicate positional relationships of the respective features. Alternatively, it can also be said that vector directions of output vectors of the two nodes indicate feature variations. For example, when the node corresponds to a feature of an “eye”, a direction of the output vector may express variations such as smallness of an eye and an almond-shaped eye. It is said that, in the general convolution neural network, space information relating to a feature is lost due to pooling processing. As a result, as compared to the general convolution neural network, the vector neural network and the capsule network are excellent in a function of distinguishing input data.

The advantageous points of the vector neural network can be considered as follows. In other words, the vector neural network has an advantageous point in that an output vector of the node expresses features of the input data as coordinates in a successive space. Therefore, the output vectors can be evaluated in such a manner that similar vector directions show similar features. Further, even when features contained in input data are not covered in teaching data, the features can be interpolated and can be distinguished from each other, which is also an advantageous point. In contrast, in the general convolution neural network, disorderly compaction is caused due to pooling processing, and hence features in input data cannot be expressed as coordinates in a successive space, which is a drawback.

An output of each of the node in the ConvVN2 layer 250 and the ClassVN layer 260 are similarly determined through use Equation (E1) to Equation (E4) given above, and detailed description thereof is omitted. A resolution of the ClassVN layer 260 being the uppermost layer is 1×1, and the number of channels thereof is Nm. An output of each of the nodes of the PreBranchedClassVN layer 271 and the PostBranchedClassVN layer 272 forming the branched output layer 270 is determined similarly using Equation (E1) to Equation (E4) given above.

An output of the ClassVN layer 260 is converted into the plurality of determination values Class_0 and Class_Nm−1 for the known classes. In general, those determination values are values obtained through normalization with the softmax function. Specifically, for example, a vector length of an output vector is calculated from the output vector of each of the nodes in the ClassVN layer 260, and the vector length of each of the nodes is further normalized with the softmax function. By executing this calculation, a determination value for each of the classes can be obtained. As described above, the activation value aⱼ obtained by Equation (E3) given above is a value corresponding to a vector length of the output vector M^{L+1}ⱼ, and is normalized. Therefore, the activation value aⱼ of each of the nodes in the ClassVN layer 260 may be output, and may be used directly as a determination value of each of the classes. Those circumstances are similar to the determination values #Class_0 to #Class_Nm−1 of the PostBranchedClassVN layer 272.

In the exemplary embodiment described above, as the machine learning model 200, the vector neural network that obtains an output vector by an a calculation with Equation (E1) to Equation (E4) given above is used. Instead, the capsule network disclosed in each of U.S. Pat. No. 5,210,798 and WO 2019/083553 may be used.

Other Aspects:

The present disclosure is not limited to the exemplary embodiment described above, and may be implemented in various aspects without departing from the spirits of the disclosure. For example, the present disclosure can also be achieved in the following aspects. Appropriate replacements or combinations may be made to the technical features in the above-described exemplary embodiment which correspond to the technical features in the aspects described below to solve some or all of the problems of the disclosure or to achieve some or all of the advantageous effects of the disclosure. Additionally, when the technical features are not described herein as essential technical features, such technical features may be deleted appropriately.

(1) According to a first aspect of the present disclosure, there is provided a classification device configured to execute classification processing for data to be classified using a machine learning model including a vector neural network including a plurality of vector neuron layers. The machine learning model includes an input layer, an intermediate layer, and a first output layer and a second output layer that are branched from the intermediate layer, the first output layer is configured to use a first activation function, and the second output layer is configured to use a second activation function that is different from the first activation function.

With the classification device, the second output layer uses the activation function different from that of the first output layer. Thus, the explanatory information with high reliability for classification can be generated using any one of the first output layer and the second output layer.

(2) With the classification device described above, the first activation function may be a softmax function.

With the classification device, the explanatory information with high reliability can be generated using the second output layer that uses the second activation function different from the softmax function.

(3) With the classification device described above, the pre layer may be configured to use the second activation function, and the post layer may be configured to use the softmax function.

With the classification device, the explanatory information with high reliability can be generated using the pre layer. Further, the post layer uses the softmax function, learning of the second output layer can successfully be executed.

(4) The classification device described above may include a classification processing unit configured to execute the classification processing using the machine learning model, and a memory configured to store the machine learning model and a known feature spectrum group that is obtained from an output of the second output layer when a plurality of pieces of teaching data are input to the machine learning model. The classification processing unit may be configured to execute processing (a) of reading out the machine learning model from the memory, processing (b) of reading out the known feature spectrum group from the memory, and processing (c) of determining a corresponding class of the data to be classified using the machine learning model. The processing (c) may involve processing (c1) of calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified, processing (c2) of determining the corresponding class of the data to be classified, based on any one of an output of the first output layer, an output of the second output layer, and the similarity degree, and processing (c3) of displaying the corresponding class of the data to be classified and the explanatory information.

With the classification device, the similarity degree for each class between the feature spectrum obtained from an output of the second output layer and the known feature spectrum group can be utilized as the explanatory information with high reliability.

(5) With classification device described above, the specific layer included in the second output layer may have a configuration in which a vector neuron arranged in a plane defined with two axes including a first axis and a second axis is arranged as a plurality of channels along a third axis being a direction different from the two axes. The feature spectrum may be any one of (i) a first type of a feature spectrum obtained by arranging a plurality of element values of an output vector of a vector neuron at one plane position in the specific layer, over the plurality of channels along the third axis, (ii) a second type of a feature spectrum obtained by multiplying each of the plurality of element values of the first type of the feature spectrum by an activation value corresponding to a vector length of the output vector, and (iii) a third type of a feature spectrum obtained by arranging the activation value at one plane position in the specific layer, over the plurality of channels along the third axis.

With the classification device, the feature spectrum can easily be obtained.

(6) According to a second aspect of the present disclosure, there is provided a method of executing classification processing for data to be classified using a machine learning model including a vector neural network including a plurality of vector neuron layers. The method includes (a) reading out the machine learning model from a memory, the machine learning model having an input layer, an intermediate layer, and a first output layer and a second output layer that are branched from the intermediate layer, the first output layer being configured to use a first activation function, the second output layer being configured to use a second activation function that is different from the first activation function, (b) reading out a known feature spectrum group from the memory, the known feature spectrum group being obtained from an output of the second output layer when a plurality of pieces of teaching data are input to the machine learning model, and (c) determining a corresponding class of the data to be classified using the machine learning model. The item (c) includes (c1) calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified, (c2) determining the corresponding class of the data to be classified, based on any one of an output of the first output layer, an output of the second output layer, and the similarity degree, and (c3) displaying the corresponding class of the data to be classified and the explanatory information.

With this method, the similarity degree for each class between the feature spectrum obtained from an output of the second output layer and the known feature spectrum group can be utilized as the explanatory information with high reliability.

(7) According to a third aspect of the present disclosure, there is provided a non-transitory computer-readable storage medium storing a computer program for causing a processor to execute classification processing for data to be classified using a machine learning model including a vector neural network including a plurality of vector neuron layers. The computer program causes the processor to execute processing (a) of reading out the machine learning model from a memory, the machine learning model having an input layer, an intermediate layer, and a first output layer and a second output layer that are branched from the intermediate layer, the first output layer being configured to use a first activation function, the second output layer being configured to use a second activation function that is different from the first activation function, processing (b) of reading out a known feature spectrum group from the memory, the known feature spectrum group being obtained from an output of the second output layer when a plurality of pieces of teaching data are input to the machine learning model, and processing (c) of determining a corresponding class of the data to be classified using the machine learning model. The processing (c) involves processing (c1) of calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified, processing (c2) of determining the corresponding class of the data to be classified, based on any one of an output of the first output layer, an output of the second output layer, and the similarity degree, and processing (c3) of displaying the corresponding class of the data to be classified and the explanatory information.

The present disclosure may be achieved in various forms other than the above-mentioned aspects. For example, the present disclosure can be implemented in forms including a computer program for achieving the functions of the classification device, and a non-transitory storage medium storing the computer program.

What is claimed is:

1. A classification device configured to execute classification processing for data to be classified using a machine learning model including a vector neural network including a plurality of vector neuron layers, wherein
the machine learning model includes an input layer, an intermediate layer, and a first output layer and a second output layer that are branched from the intermediate layer,
the first output layer is configured to use a first activation function, and
the second output layer is configured to use a second activation function that is different from the first activation function.

2. The classification device according to claim 1, wherein
the first activation function is a softmax function.

3. The classification device according to claim 2, wherein
the second output layer includes a pre layer on a lowermost side and a post layer on an upper most side, and
the pre layer is configured to use the second activation function, and the post layer is configured to use the softmax function.

4. The classification device according to claim 1, comprising:
a classification processing unit configured to execute the classification processing using the machine learning model; and
a memory configured to store the machine learning model and a known feature spectrum group that is obtained from an output of the second output layer when a plurality of pieces of teaching data are input to the machine learning model, wherein
the classification processing unit is configured to execute:
processing (a) of reading out the machine learning model from the memory;
processing (b) of reading out the known feature spectrum group from the memory; and
processing (c) of determining a corresponding class of the data to be classified using the machine learning model, and
the processing (c) involves:
processing (c1) of calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified;
processing (c2) of determining the corresponding class of the data to be classified, based on any one of an output of the first output layer, an output of the second output layer, and the similarity degree; and
processing (c3) of displaying the corresponding class of the data to be classified and the explanatory information.

5. The classification device according to claim 4, wherein
the specific layer included in the second output layer has a configuration in which a vector neuron arranged in a plane defined with two axes including a first axis and a second axis is arranged as a plurality of channels along a third axis being a direction different from the two axes, and
the feature spectrum is any one of:
(i) a first type of a feature spectrum obtained by arranging a plurality of element values of an output vector of a vector neuron at one plane position in the specific layer, over the plurality of channels along the third axis;
(ii) a second type of a feature spectrum obtained by multiplying each of the plurality of element values of the first type of the feature spectrum by an activation value corresponding to a vector length of the output vector; and
(iii) a third type of a feature spectrum obtained by arranging the activation value at one plane position in the specific layer, over the plurality of channels along the third axis.

6. A method of executing classification processing for data to be classified using a machine learning model including a vector neural network including a plurality of vector neuron layers, the method comprising:
(a) reading out the machine learning model from a memory, the machine learning model having an input layer, an intermediate layer, and a first output layer and a second output layer that are branched from the intermediate layer, the first output layer being configured to use a first activation function, the second output layer being configured to use a second activation function that is different from the first activation function;
(b) reading out a known feature spectrum group from the memory, the known feature spectrum group being obtained from an output of the second output layer when a plurality of pieces of teaching data are input to the machine learning model; and
(c) determining a corresponding class of the data to be classified using the machine learning model, wherein
the item (c) includes:
(c1) calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified;
(c2) determining the corresponding class of the data to be classified, based on any one of an output of the first output layer, an output of the second output layer, and the similarity degree; and
(c3) displaying the corresponding class of the data to be classified and the explanatory information.

7. A non-transitory computer-readable storage medium storing a computer program for causing a processor to execute classification processing for data to be classified using a machine learning model including a vector neural network including a plurality of vector neuron layers, the computer program for causing the processor to execute:
processing (a) of reading out the machine learning model from a memory, the machine learning model having an input layer, an intermediate layer, and a first output layer and a second output layer that are branched from the intermediate layer, the first output layer being configured to use a first activation function, the second output layer being configured to use a second activation function that is different from the first activation function;
processing (b) of reading out a known feature spectrum group from the memory, the known feature spectrum group being obtained from an output of the second output layer when a plurality of pieces of teaching data are input to the machine learning model; and
processing (c) of determining a corresponding class of the data to be classified using the machine learning model, wherein
the processing (c) involves:
processing (c1) of calculating a similarity degree between a feature spectrum and the known feature spectrum group, the feature spectrum being obtained from an output of the second output layer when the data to be classified is input to the machine learning model, and generating the similarity degree as explanatory information relating to a classification result of the data to be classified;
processing (c2) of determining the corresponding class of the data to be classified, based on any one of an output of the first output layer, an output of the second output layer, and the similarity degree; and
processing (c3) of displaying the corresponding class of the data to be classified and the explanatory information.
